(19) United States
(12) Patent Application Publication
(10) Pub. No.: US 2004/0117636 A1
(43) Pub. Date: Jun. 17, 2004

(54) System, method and apparatus for secure two-tier backup and retrieval of authentication information

(76) Inventor: David Cheng, Degany (GB)

Correspondence Address: LUMEN INTELLECTUAL PROPERTY SERVICES, INC., 2345 YALE STREET, 2ND FLOOR, PALO ALTO, CA, 94306, US

(21) Appl. No.: 10/670,755

(22) Filed: Sep. 24, 2003

Related U.S. Application Data
(60) Provisional application No. 60/413,897, filed on Sep. 25, 2002.

(51) Int. Cl. H04L 9/00

(52) U.S. Cl. 713/185

(57) ABSTRACT

The present invention provides new ways to securely backup and restore a user's portable biometrics-based authentication device without compromising the secrecy thereof. A two-tier backup encryption structure allows the decryption of lower tier data only when upper tier data has been decrypted and validated. The structure can be expressed as:

Backup={biometrics data+any validation scripts/keys/values+(associated data)},

where

( ) represents the lower tier encryption; and

{ } represents the upper tier encryption.

The lower tier data contain encrypted electronic identity of a user and authentication information associated therewith such as private keys and corresponding certificates. The upper tier data contain the encrypted lower tier data and the user's biometrics information.

### CROSS-REFERENCE TO RELATED APPLICATIONS

This application claims the benefit of a provisional patent application No. 60/413,897, filed Sep. 25, 2002, the entire content and appendices of which are hereby incorporated by reference.

### FIELD OF THE INVENTION

The present invention relates generally to portable authentication devices. More particularly, it relates to a new and useful system, method, and apparatus for generating secure back up of authentication information of a user and for restoring the authentication information back onto a portable authentication device.

### DESCRIPTION OF THE RELATED ART

With the rapid growth of computers, electronics, communications, networks, and the Internet, access control in general and network security in particular have become increasingly important for obvious reasons. Data, property interests, personal identity as well as personal safety could be at risk if security is breached. To satisfy different security needs, various authentication systems, methods, and devices exist today and new ones are continually being developed. In general, authentication involves the verification of one or more elements, factors, or parameters to grant access or to certify the validity of an identity, account, object, and so on. In the most basic form, this could relate to the possession of a key that matches the keyhole to open a door. It could also relate to the possession of a seal or a stamp that could be applied to a document to establish or prove authority or ownership. An authentication device that holds the electronic identity of the user is essential in preventing identity theft and/or unwanted intruders. Instead of having possession of an authentication device, one could also have knowledge of a particular password or code such as a personal identification number (PIN) in combination with the use of a bankcard. Unfortunately, with advances in technologies, these traditional authentication systems, methods and devices have become relatively easy to breach or bypass and therefore are quite vulnerable to trespassers and various security attacks.

Biometrics-based authentication is emerging as a reliable method that offers better security than traditional authentication including automated personal identification technologies. Biometrics technologies enable the use of physiological and/or behavioral characteristics of a person to establish his/her identity or to authenticate his/her claim to a certain identity. Examples of such personal characteristics are numerous, including fingerprints, palm prints, handwritings, signatures, iris patterns, retina scans, voice prints, facial recognition, personal geometry, DNA, etc.

The combination of biometrics and traditional authentication is known in the art. For example, U.S. Pat. No. 5,815,252, entitled “BIOMETRIC IDENTIFICATION PROCESS AND SYSTEM UTILIZING MULTIPLE PARAMETERS SCANS FOR REDUCTION OF FALSE NEGATIVES”, issued to Price-Francis and assigned to Canon, utilizes the combination of a fingerprint and a PIN to overcome problems with false positive and false negative responses. For other exemplary teachings on biometric-based authentication systems and devices including portable ones, readers are referred to U.S. Pat. No. 6,213,391 “PORTABLE SYSTEM FOR PERSONAL IDENTIFICATION BASED UPON DISTINCTIVE CHARACTERISTICS OF THE USER” issued to Lewis; U.S. Pat. No. 6,219,439 “BIOMETRIC AUTHENTICATION SYSTEM” issued to Burger; U.S. Pat. No. 6,325,285 “SMART CARD WITH INTEGRATED FINGERPRINT READER” issued to Baratelli and assigned to AT&T; and U.S. Pat. No. 6,353,889 “PORTABLE DEVICE AND METHOD FOR ACCESSING DATA KEY ACTUATED DEVICES” issued to Hollingshead and assigned to Mytec.

A method commonly utilized by portable authentication devices including biometrics-based authentication devices such as smart cards is to have a secret key generated and stored within the portable device. The secret key so generated cannot be revealed outside of or retrieved from the device. In the event of loss, damage, or destruction of the device, the user's authentication information, electronic identity and any data associated therewith would be lost forever. Indeed, to prevent or at least to minimize the possibility of compromising the secrecy of the electronic identity and the authentication information, when a portable authentication device is reported loss or stolen, the general practice is to first deactivate or erase completely from the authentication system or secure network the electronic identity and authentication information associated with the lost/stolen authentication device and then create and register new ones from scratch. A new or replacement authentication device is then programmed and issued. Despite cost and inconvenience, such extreme precaution is necessary because currently there are no reliable and secure ways to backup and restore authentication information and electronic identities generated and stored on portable authentication devices.

### SUMMARY

The present invention provides new ways to securely backup and restore a user's authentication information, electronic identity and any data associated therewith, without compromising the secrecy thereof. In particular, the present invention provides new ways to backup and restore data generated and stored on portable biometrics-based authentication devices. Enabling technologies include biometrics, authentication, cryptography, and encryption/decryption. A foundational aspect of the present invention is the concept of a two-tier backup encryption structure having a first encryption means for enciphering lower tier data and a second encryption means for enciphering upper tier data.

The lower tier data contain encrypted electronic identity such as private keys and associated certificates. The upper tier data contain the encrypted lower tier data, restore validation script, and biometrics data. To backup a device, the lower tier data are first enciphered using the first encryption means. The upper tier data are then enciphered using the second encryption means. In an embodiment, the encryption keys for both the upper and lower tiers are separately generated within the device. In a preferred embodiment, the device obtains a first encryption key from a first user service bureau. The lower tier data is encrypted with this first encryption key. Then, the device obtains a second encryption key from a second user service bureau, which may or may not be the same as the first user service bureau, and the upper tier data are further encrypted using the second encryption key, generating a multiple-encrypted backup file. The multiple-encrypted backup file is then copied to a storage medium of user's choice.

To restore the multiple-encrypted backup data onto a new biometrics-based authentication device, the user first needs to enroll the relevant biometrics in the new device and upload the multiple-encrypted backup data onto the device, then contact the corresponding user service bureau to obtain an access clearance to the encrypted lower and upper tier encryption keys. The access clearance enables the device to establish a secure connection with the user service bureau service. Upon establishing the secure connection, the restore process begins automatically. The device first requests the upper tier data decryption key from the user service bureau server to decipher the encrypted upper tier data. The device then compares the decrypted backup biometrics data with the newly enrolled biometrics data. If they match, then the newly enrolled biometrics data are replaced with the decrypted backup biometrics data. Only then, will the system confirm the match to the user service bureau server and request the lower tier decryption key. Once the lower tier decryption key is received, the lower tier data is deciphered and stored in the device. This completes the restore process. If they do not match, the restore process is terminated. When the restore process is complete or otherwise terminated, the device automatically disconnects from the user service bureau and communicates the results to the user.

### BRIEF DESCRIPTION OF THE DRAWINGS

FIG. 1 illustrates a two-tier backup encryption structure according to the principles of the present invention.

FIG. 2 schematically shows an exemplary portable biometrics-based authentication device configuration implementing the present invention.

FIGS. 3A-3B demonstrate an exemplary backup process according to an aspect of the invention.

FIGS. 4A-4C show an exemplary restore process according to an aspect of the invention.

FIG. 5 illustrates restore options offered during the back-up process of a device configured to implement the present invention.

### DETAILED DESCRIPTION

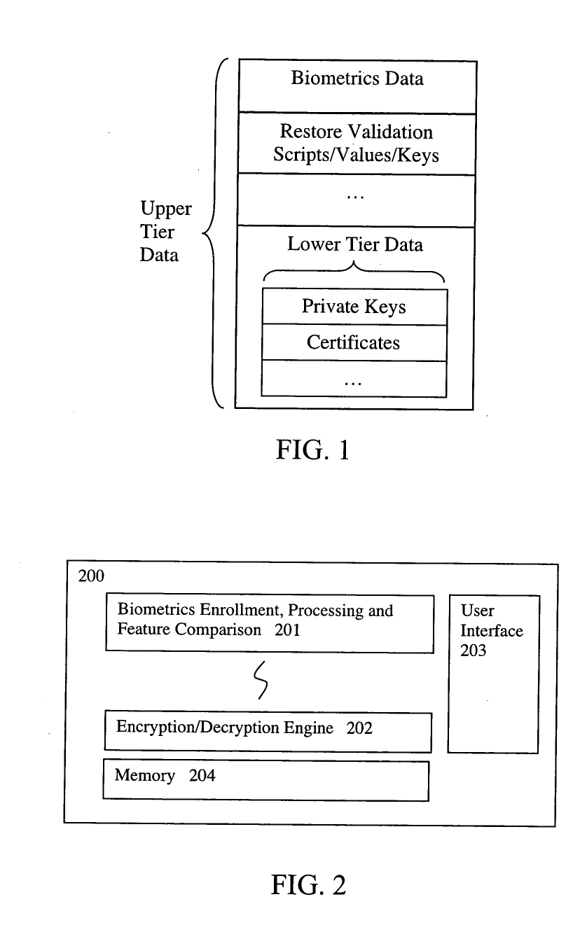

FIG. 1 shows a two-tier backup encryption structure that allows the decryption of lower tier data only when upper tier data has been decrypted and validated. The structure can be expressed as:

Backup={biometrics data+any validation scripts/keys/values+(associated authentication data such as electronic identity, private keys, certificates, and the like)}, where

( ) represents the lower tier data encrypted with a lower tier encryption; and

{ } represents the upper tier data encrypted with an upper tier encryption, the upper tier data encompasses the encrypted lower tier data.

The Backup in one embodiment is realized in one physical file where the lower tier and upper tier data are combined as one file. Alternatively, each tier is backed up in one or more physical files. For example,

Backup 1=encrypted upper tier data; and

Backup 2=encrypted lower tier data, where

Backup 1 is encrypted with an upper tier encryption key and Backup 2 is encrypted with a lower tier encryption key. Preferably, as discussed herein, these two keys are separately obtained from a Web-based user service bureau that adheres to the highest possible security level according to the Internet protocol.

FIG. 2 shows an exemplary portable biometrics-based authentication device configuration implementing the present invention. The portable device 200 has a user interface means 203 which could be text-based or graphical and a data storage or memory means 204 that is tamper resistant and protected from corruption. An encryption/decryption engine 202 enciphers and deciphers data received and/or stored in the memory means 204. The portable device 200 includes a biometrics processing means 201 for enrolling, processing and comparing biometrics information such as fingerprints, palm prints, handwritings, signatures, iris patterns, retina scans, voice prints, facial recognition, personal geometry, DNA, etc. Onboard microprocessor and communication means (not shown) handle communication, interact with a graphic user interface (GUI), e.g., of a personal computer or computing device, and other processing needs such as establishing a secure connection with a remote service bureau, requesting and returning encryption/decryption keys, creating and copying lower tier and upper tier backup files, and terminating the connection. Other biometrics-based authentication devices can also be configured and/or programmed to perform the methods of this invention, and to the extent that a particular configuration is capable of performing the methods of this invention, it is equivalent to the exemplary portable biometrics-based authentication device of FIG. 2, and within the scope and spirit of the present invention. Once they are programmed and/or configured to perform particular functions pursuant to the computer-executable instructions from computer program software that implements the methods of this invention, such biometrics-based authentication devices in effect become special-purpose apparatuses particular to the methods disclosed herein. The techniques necessary to realize such programming and/or configuring are well known to those skilled in the art and thus are not further described here.

According to an aspect of the invention, a method for creating a secure backup of a portable biometrics-based authentication device includes the following steps:

(a) obtaining a lower tier encryption key from a user service bureau;

(b) enciphering lower tier authentication data using the lower tier encryption key, thereby creating an encrypted lower tier backup file;

(c) obtaining an upper tier encryption key from the user service bureau;

(d) enciphering upper tier authentication data using the upper tier encryption key, thereby creating an encrypted upper tier backup file; and

(e) storing the encrypted lower tier backup file and the encrypted upper tier backup file on a storage means.

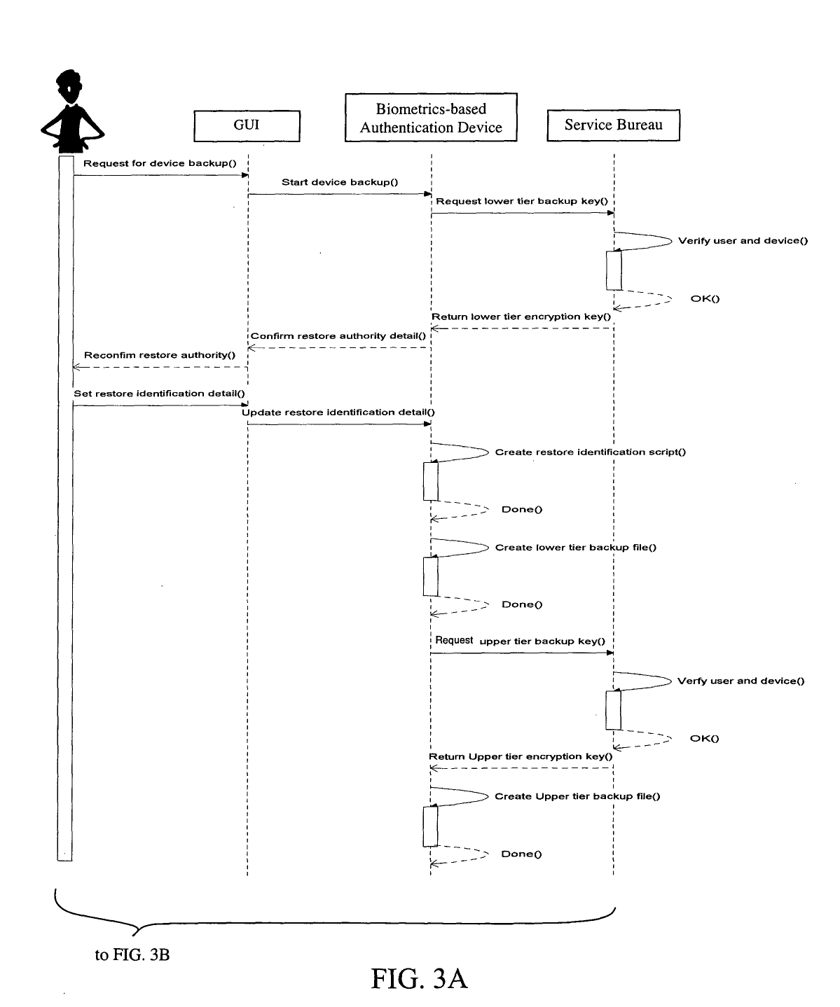

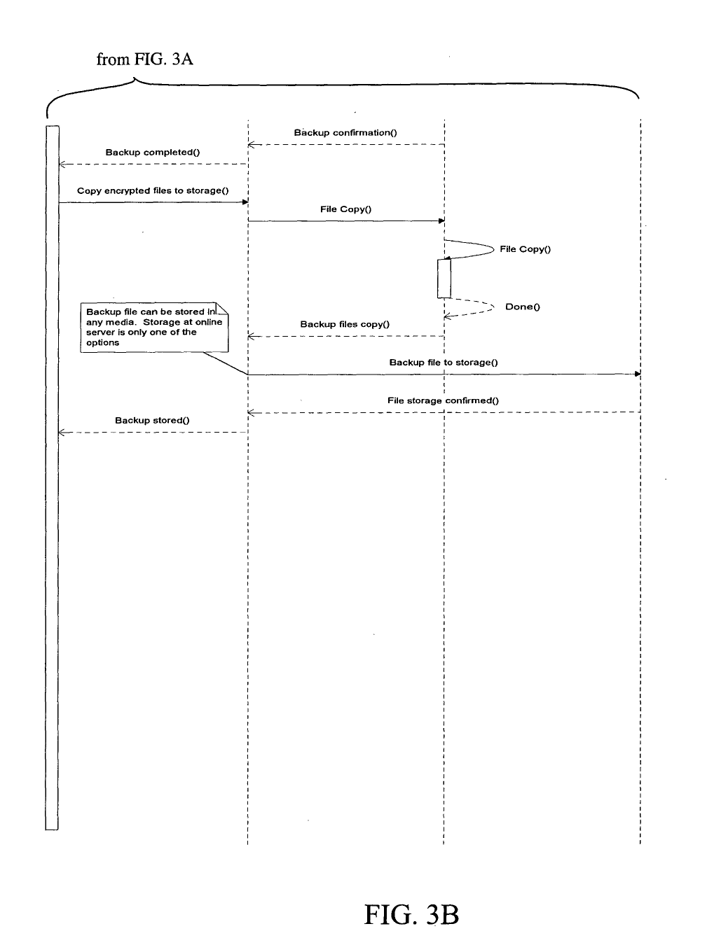

An exemplary backup process is illustrated in FIGS. 3A-3B. The storage means could be, for instance, an online proprietary or Internet-based storage service, a remote server, a floppy disk, a hard drive, a data drive, a CD-ROM, an optical storage means, a removable disk, a smart card, a memory storage device or any other storage media capable of storing data. The user service bureau could be proprietary or Internet-based and could also provide the storage service. It is important that a secure communication between the user service bureau and the portable biometrics-based authentication device can be established. Preferably, the user service bureau utilizes public networks such as the Internet and adopts the highest possible level of secure communication available via the Internet protocol.

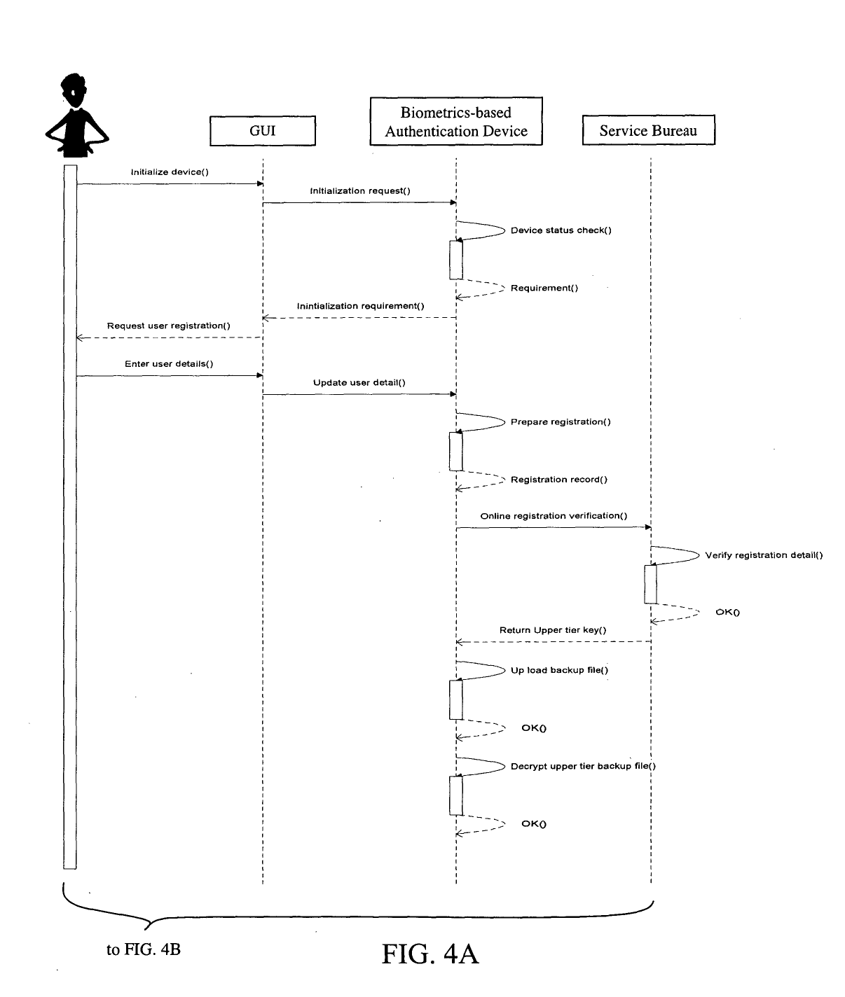

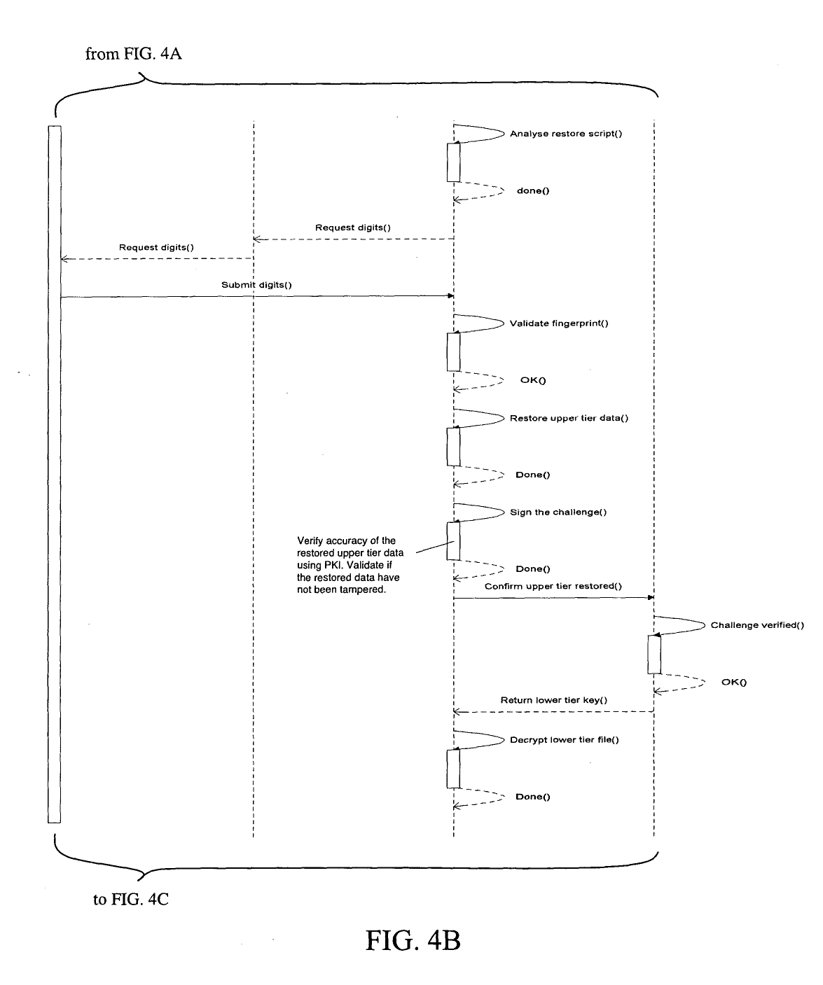

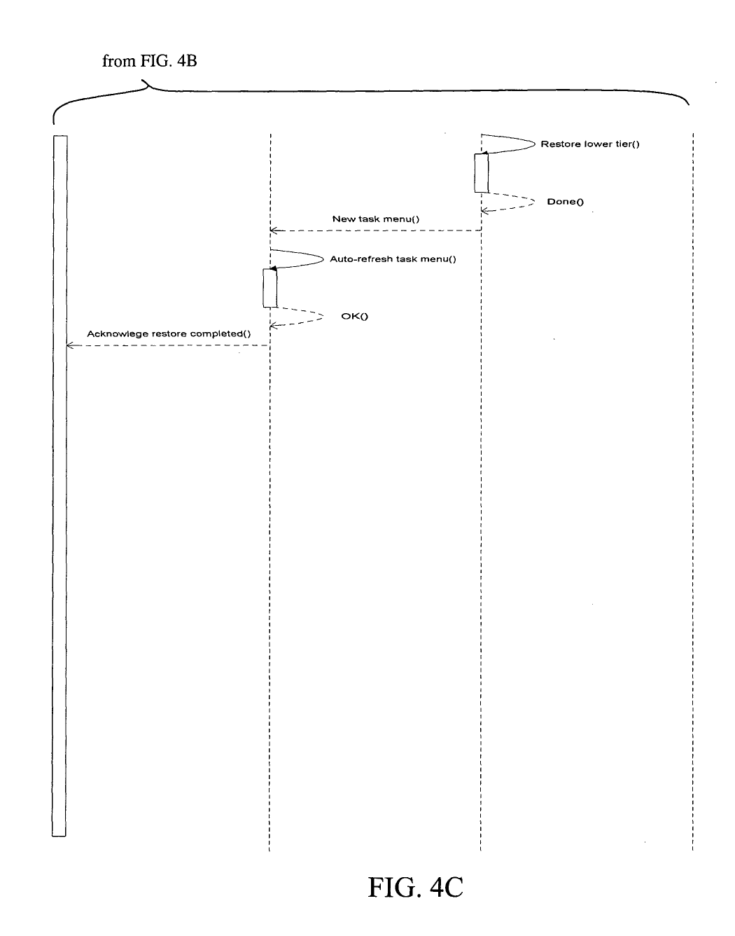

In a preferred embodiment, the lower tier authentication data include private keys, certificates, and other data held within the device. In this embodiment, the upper tier authentication data include the user's biometrics information. The upper tier authentication data could also include a restore authentication script for guiding the authentication device during a restore biometric matching processing (e.g., not all 10-digit match will be required during the restore process) as well as validation data required by the user service bureau during a restore process such as one illustrated in FIGS. 4A-4C.

According to an aspect of the invention, a method for restoring a portable biometrics-based authentication device utilizes the concept of the two-tier backup structure disclosed above. Thus, it is assumed that the authentication information is stored in a lower tier backup file and an upper tier backup file on a storage device. It is also assumed that the upper tier backup file includes the user's biometrics information. The method of restoring authentication information of a user includes the following steps:

(a) verifying registration information of the user with a user service bureau;

(b) downloading an upper tier encryption key from the user service bureau to the portable biometrics-based authentication device;

(c) deciphering the encrypted upper tier backup file using the upper tier encryption key;

(d) restoring onto the portable biometrics-based authentication device the upper tier authentication data from the decrypted upper tier backup file which includes the user's backup biometrics data and any validation scripts, keys, and/or values;

(e) validating newly enrolled biometrics data with the backup biometrics data based on the restore authentication script or preset requirements;

(f) downloading a lower tier encryption key from the user service when the validation is successful;

(g) deciphering the lower tier backup file using the lower tier encryption key; and

(h) restoring onto the portable biometrics-based authentication device the lower tier authentication data from the decrypted lower tier backup file.

In some embodiments, a restore validation script is executed during the restore process for selective validation. This is useful in cases where a user does not have all the biometrics data available due to sickness, accident, etc. For example, the user might have only nine fingers. The restore authentication script describing customized, selective restore requirements can be an option as the device could always have predefined (default) restore requirements. The following illustrates an exemplary restore validation script and its usage.

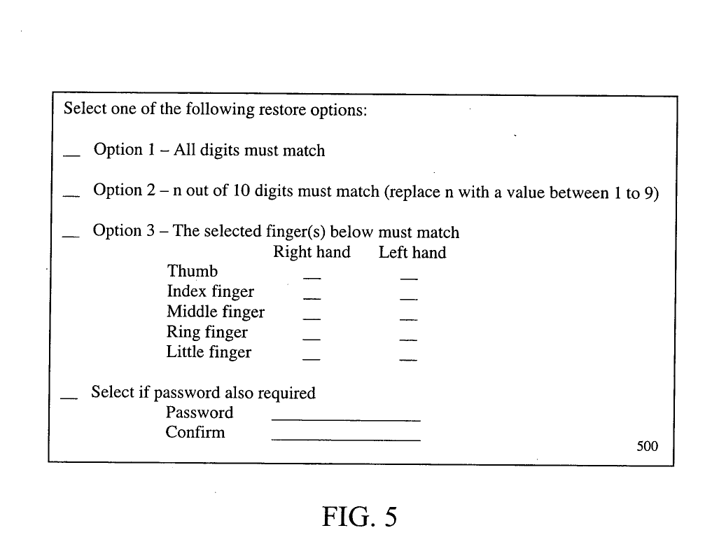

FIG. 5 shows a representative screen of a GUI 500. The screen displays restore options offered by a biometrics-based authentication device during a backup process. For example, the biometrics-based authentication device may contain ten biometric factors such as ten digits of a user. During the backup process, the user can choose how many digits must match during a restore process. Preferably, all ten newly enrolled digits are required to match the ten backup ones. Alternatively, the user can select what fingers of which hand must match during the restore process. In addition, the user can require that a correct password be entered during the restore process. One skilled in the art would appreciate that the restore options shown in FIG. 5 are for illustration purposes only and can be tailored to accommodate different designs, needs, and so on, e.g., different types of biometrics utilized by the biometrics-based authentication device.

After the user selects a restore option, the restore validation data is stored and a restore validation script is created. The following is an exemplary restore validation script, assuming that Option 3 is selected, index finger of right hand and thumb of left hand are marked, and a password is required.

START

| | |
|---|---|
| REQUEST PASSWORD | ***User enter password |

via GUI

IF PASSWORD NOT MATCH

GO TO ERROR_RETURN

END-IF

| | |
|---|---|
| VERIFY RIGHT_HAND_INDEX_{—} | ***Match enrollment |
| FINGER | with restored data |

IF NOT MATCH

GO TO ERROR_RETURN

END-IF

| | |
|---|---|
| VERIFY LEFT_HAND_THUMB | *Match enrollment with |

restored data

IF NOT MATCH

GO TO ERROR_RETURN

END-IF
GO TO OK_RETURN

ERROR_RETURN

.
.
.

OK_RETURN

.
.
.

END

During the restore process the above restore validation script is executed for selective validation. One skilled in the art would appreciate that different restore validation scripts can be created that correspond to different options selected. Alternatively, as discussed herein, such a restore validation script can be optional since the biometrics-based authentication device could have predefined restore requirements.

The present invention can be implemented in essentially any and all types of biometrics-based authentication devices especially portable ones including smart cards, access cards, identification cards, credit cards, bank cards, and the like. An exemplary application of the present invention is as follows:

1. A user's biometrics-based authentication device becomes unavailable due to loss, damage, destruction, theft, etc.

2. The user obtains a new biometrics-based authentication device. There is no need to report the unavailability of the old one since it is substantially difficult if not impossible to replicate the user's biometrics information due to the nature of each individual's uniqueness.

3. The user enrolls the new biometrics-based authentication device with an enrollment service/user service bureau, i.e., enrolling new biometrics data onto the authentication device.

4. The new biometrics-based authentication device establishes a secure connection with a user service bureau, begins the restore process and downloads backup data from storage.

5. The new biometrics-based authentication device is validated and the backup (original) enrollment is restored onto the new authentication device.

6. The new biometrics-based authentication device is available for use.

Although the present invention and its advantages have been described in detail, it should be understood that the present invention is not limited to or defined by what is shown or described herein. Known methods, systems, or components may be discussed without giving details, so to avoid obscuring the principles of the invention. For example, the techniques necessary to establish a secure connection and upload or download data are well known in the art and thus are not further described herein. As it will be appreciated by one of ordinary skill in the art, various changes, substitutions, and alterations could be made or otherwise implemented without departing from the principles of the present invention. Thus, examples and drawings disclosed herein are for purposes of illustrating a preferred embodiment(s) of the present invention and are not to be construed as limiting the present invention. Accordingly, the scope of the invention should be determined by the following claims and their legal equivalents.

What is claimed is:

1. A method for backing up a biometrics-based authentication device comprising the steps of:
obtaining a first encryption key;
enciphering lower tier data with said first encryption key to generate an encrypted lower tier backup file;
obtaining a second encryption key; and
enciphering upper tier data with said second encryption key to generate an encrypted upper tier backup file, wherein said lower tier data contain encrypted identification of a user and authentication information associated therewith and wherein said upper tier data contain biometrics data of said user and said lower tier data encrypted with said first encryption key.

2. The method according to claim 1, wherein
said authentication information comprises private keys and corresponding certificates.

3. The method according to claim 1, further comprising the step of:
generating a restore validation script for establishing restore requirements of said upper tier data.

4. The method according to claim 3, wherein
said upper tier data further contain said restore validation script.

5. The method according to claim 1, further comprising the step of:
establishing a secure connection with a service bureau.

6. The method according to claim 5, further comprising the step of:
obtaining said first and said second encryption keys from said service bureau.

7. The method according to claim 1, further comprising the step of:
storing said encrypted lower tier backup file and said encrypted upper tier backup file as one or more physical files.

8. A method for restoring onto a new biometrics-based authentication device said lower tier data and said upper tier data according to claim 1, comprising the steps of:
enrolling new biometrics data of said user onto said new biometrics-based authentication device;
obtaining an upper tier data decryption key;
deciphering said encrypted upper tier backup file with said upper tier data decryption key to generate decrypted upper tier data including decrypted biometrics data;
determining, based on said decrypted biometrics data, whether said new biometrics data are valid;
obtaining a lower tier data decryption key when said new biometrics data are valid;
deciphering said encrypted lower tier data with said lower tier data decryption key to generate decrypted lower tier data; and
storing said decrypted lower tier data onto said new biometrics-based authentication device.

9. The method according to claim 8, further comprising the steps of:
uploading said encrypted lower tier backup file and said encrypted upper tier backup file onto said new biometrics-based authentication device;
obtaining an access clearance from a service bureau; and
establishing a secure connection with said service bureau using said access clearance.

10. The method according to claim 9, further comprising the step of:
obtaining said upper tier data decryption key and said lower tier data decryption key from said service bureau.

11. The method according to claim 8, further comprising the step of:
verifying that said decrypted upper tier data have not been tampered or altered.

12. An apparatus for implementing the method according to claim 1 or 8, wherein
said apparatus is configured to perform the steps of claim 1 or 8.

13. An article of manufacture for implementing the method according to claim 1 or 8,
wherein said article of manufacture comprising a computer readable medium carrying computer-executable instructions implementing the steps of claim 1 or 8.
